(19) United States
(12) Patent Application Publication
(10) Pub. No.: US 2015/0059220 A1
(43) Pub. Date: Mar. 5, 2015

(54) Bracket apparatus for road sign

(71) Applicant: Poen tech Co., Itd, Busan (KR)

(72) Inventor: Gwangchun Lim, Busan (KR)

(73) Assignee: Poen tech Co., Itd, Busan (KR)

(21) Appl. No.: 14/011,622

(22) Filed: Aug. 27, 2013

(51) Int. Cl. G09F 7/18

(52) U.S. Cl. CPC G09F 7/18
USPC 40/607.14

(57) ABSTRACT

This invention is about a bracket apparatus for road sign that connects a road sign to the support, and more in detail, it is about the bracket apparatus for road sign, made up of a simple connection and at the same time, having a structure including a composition for the prevention of corrosion, so a road sign can be simply connected to the support without a separate combining means and solves friction with the road sign, and can prevent abrasion and noise and reduce the impact on the road sign and prevent the damage of appearance of the road sign due to corrosion.

### TECHNICAL FIELD

This invention is about a bracket apparatus for road signs that connects a road sign to the support, and more in detail, it is about the bracket apparatus for road signs, made up of a simple connection and at the same time, having a structure including a composition for the prevention of corrosion, so a road sign can be simply connected to the support without a separate combining means and solves friction with the road sign, and can prevent abrasion and noise and reduce the impact on the road sign and prevent the damage of appearance of the road sign due to corrosion.

### BACKGROUND ART

In general, road signs in various kinds and shapes including road plaque displaying a road name are installed on the street or the edge of a sidewalk used for the purpose of letting drivers or pedestrian passing the road know the road name etc.

Most of the above mentioned road signs are installed at the bottom of the support fixed horizontally to the top of a traffic light pillar, a street lamp pillar and a communication pillar. Also, the road signs are connected and installed at the bottom of the support by a bracket apparatus for road sign for an exclusive use so as to be installed firmly at the bottom of the support.

Here, the bracket apparatus for road sign is made up of a structure integrated with the upper connection to the bottom of the support and the bottom connection to the top of the road sign. And the top connection and the bottom connection are respectively connected and installed to the bottom of the support and to the top of the road sign using combining means such as bolts and nuts.

Yet, since the above mentioned existing bracket apparatus for road sign is installed between the support and the road sign using the combining means such as bolts and nuts, it has a problem that the installation work of the road sign is not easy.

In addition, the above combining means such as bolts and nuts have a problem in which the road sign easily wavers and looses with the influence of the wind, so the connection status of the road sign is not solid and gets rust due to corrosion by rainwater and the appearance of the road sign gets damaged.

### SUMMARY

To achieve these objects and other advantages and in accordance with the purpose of the embodiments, as embodied and broadly described herein, A bracket apparatus for road sign comprising: a connecting bracket including a protrusion device formed at the top thereof and a link with a side in a ring shape in which one end of the top opened longitudinally at the bottom thereof; a member for noise prevention with a side in a ring shape cut out longitudinally so as to be installed inside the link horizontally in the tight fit method.

### BRIEF DESCRIPTION OF THE DRAWINGS

FIG. 1 is an illustration of installation according to an example of desirable implementation of this invention.

FIG. 2 is a perspective according to the example of desirable implementation of this invention.

FIG. 3 is a separated perspective according to the example of desirable implementation of this invention.

FIG. 4 is a cross-sectional diagram of Line A-A′ of Drawing 2.

### DETAILED DESCRIPTION

The bracket apparatus for road sign according to this invention is a means to install road signs in various kinds and shapes including road plaque displaying the road name at the bottom of the support fixed horizontally to the top of a traffic light pillar, a street lamp pillar and communication pillar.

Especially, the bracket apparatus for road sign according to this invention is characterized by a structure that does not get noise and abrasion at the gap with the road sign in spite of wavering by the wind etc. along with a structure installed between the support and the road sign simply through the combining structure by the shape, unlike the existing structure connected and installed by combining means such as bolts and nuts,

These structural characteristics are made possible by the composition including a protrusion device interpolated and stuck horizontally in a shoulder groove formed at the bottom of the support; a connecting bracket in which a link extrapolated horizontally to the top of the road sign and then inserted in the connecting groove of road sign is integrated at the top and bottom and a member for noise prevention installed inside of the link of the connecting bracket.

Accordingly, when a road sign is installed to the support, the road sign and support can be connected easily through the protrusion device and the link of the connecting bracket without any separate combining means such as bolts and nuts.

In addition, as no combining means such as bolts and nuts is necessary, the existing negative effect that the appearance of the road sign is damaged due to rust generated by the corrosion of the combining means due to rainwater etc. can be solved.

Also, it can solve direct friction with the road sign by a member for noise prevention installed inside of the connecting bracket to prevent noise and abrasion due to the above friction.

Additionally, as it connects the road sign so as to move it naturally back and forth on the link of the connecting bracket, it moves naturally back and forth naturally when a pressure is added to the road sign by the wind etc. so that the impact of the pressure can be reduced.

An example of desirable implementation of this invention referring to the attached drawings can be described as follows.

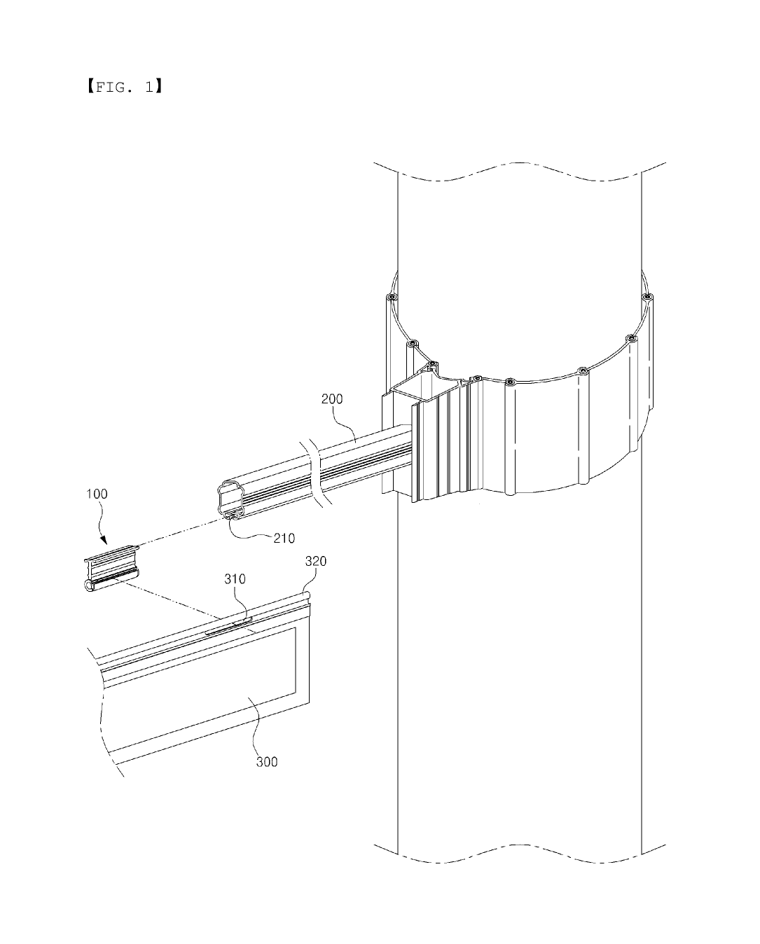

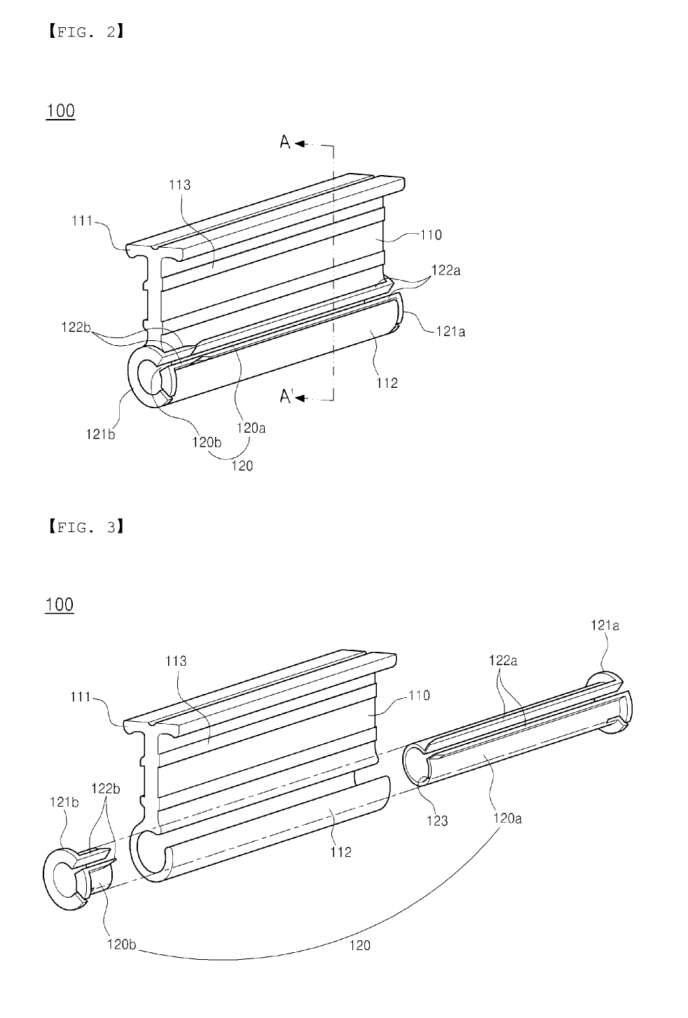

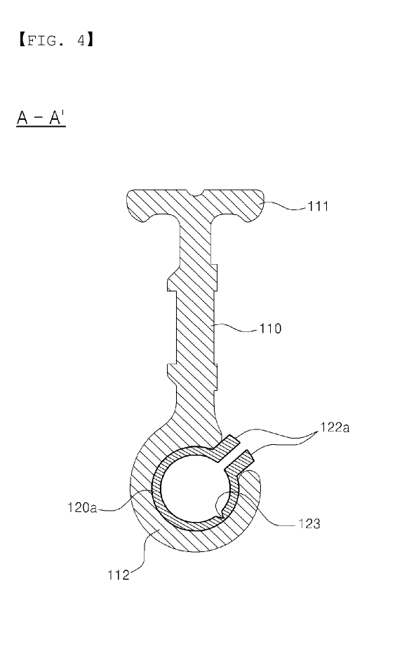

FIG. 1 is an illustration of the installation according to the example of desirable implementation of this invention; FIG. 2 is a perspective according to the example of desirable implementation of this invention; FIG. 3 is a separated perspective according to the example of desirable implementation of this invention; and FIG. 4 is a cross-sectional diagram of Line A-A′ of FIG. 2.

The bracket apparatus for road sign (100) according to the example of desirable implementation of this invention is installed at the bottom of the support (200) and connects the road sign (300) to the bottom of the support (200) horizontally as illustrated in FIG. 1, which roughly consists of the connecting bracket (110) and the member for noise prevention (120).

First, the above connecting bracket (110) connects between the support (200) and the road sign (300), which has a structure in which the protrusion device (111) and the link (112) are integrated at the top and bottom as illustrated in FIG. 2 or 4.

The above protrusion device (111) is one to fix the connecting bracket (110) to the bottom of the support (200), which has a structure that it is stuck and fixed so as not to be separated downward while it is inserted horizontally to the shoulder groove (210) open longitudinally to the bottom of the support (200).

Here, it is desirable that the protrusion device (111) is composed of a “T” shaped section to be inserted and stuck in the shoulder groove (210) with a straight line shaped section as illustrated in FIG. 1, but if it is in a structure not separated while it is inserted horizontally without a separate combining means, it may be composed in any shape.

The above link (112) is one to fix the connecting bracket (110) to the top of the road sign (300), which has a structure in which it is inserted and connected to the connecting groove formed penetrating back and forth at the top of the road sign (300).

At this time, it is desirable that the link (112) is composed in a form of a ring shaped section in which one side of the top is open, which is to insert the open part into the connecting groove (310) of the road sign (300) by changing angle while the link (112) is extrapolated in a sliding method along the round guide (320) formed at the top of the road sign from a certain angle.

Like above, if the link (112) is inserted into the connecting groove of the road sign (300), the road sign (300) will be able to move naturally back and forth around the round guide (320) or the link (112).

Also, multiple furring (113) that increases mechanical intensity as illustrated in FIGS. 2 and 3 at the center of the connecting bracket (110) may be protruded with intervals at the top and bottom.

Next, the above member for noise prevention (120) is one to prevent abrasion and noise generated between the link (112) and the road sign (300), which is a structure in a ring shape section so as to be installed in the tight fit method horizontally inside of the above link (112) as illustrated in FIGS. 1 and 2.

However, it is desirable that the member for noise prevention (120) is composed in a shape in which one side is cut out so as to be inserted in the connecting groove of the road sign (300) with the link (112).

At this time, to install the member for noise prevention (120) inside of the link (112), insert the member for noise prevention (120) into the connecting groove (310) of the road sign and then insert the link (112) into the connecting groove (310) of the road sign while leaving the member for noise prevention (120) inside.

In addition, it is desirable that the member for noise prevention (120) is composed of Mono Cast (MC) nylon material with good mechanical intensity, lightweight and excellent abrasion resistance and self-lubrication so as to prevent noise and abrasion due to the friction with the road sign (300).

Here, the member for noise prevention (120) is separately composed of 1st separator (120a) installed through the interior of the one end of the above link (112) and 2nd separator (120b) installed through the interior of the other end of the above link (112) as illustrated in FIGS. 2 and 3, and it is desirable that at the end of the above 1st separator (120a) and 2nd separator (120b), close protruded parts (121a) and (121b) contacting the one end and the other end of the above link (112) are formed.

This is to prevent the connecting bracket (110) from being separated from the road sign (300) by preventing the horizontal movement of the link by the member for noise prevention (120) through the close protruded parts (121a) and (121b) tightly fixed to both ends of the link (112).

At this time, install the 1st separator (120a) on the road sign (300) first and then install the link (112) outside of that and lastly insert and install the 2nd separator (120b) to the inside of the other end of the link (112).

It is desirable that protruded ribs (122a) and (122b) are formed in the cut out part of the above 1st separator (120a) and 2nd separator (120b) that blocks the open part of the above link (112) in the state of protrusion, and the above protruded ribs (122a) and (122b) blocks the open part of the link (112) and allows the member for noise prevention (120) to move united with the link (112) and the member for noise prevention (120) is combined only at a certain angle when it is combined with the link (112).

Here, it is desirable that on one side of the interior of the 1st separator (120a), a groove (123) is formed longitudinally as illustrated in FIG. 4, which is to facilitate the work of inserting the 1st separator (120a) into the connecting groove (310) of the road sign (300) by making one side of the 1st separator (120a) open easily to the outside centering around the groove (123).

Like above, the bracket apparatus for road sign according to this invention can connect the road sign to the support without a separate combining means conveniently, prevent abrasion and noise by solving the friction with the road sign, reduce the impact on the road sign and prevent the damage of appearance of the road sign due to corrosion.

This invention by the above mentioned composition simply connects a road sign to the support through a protrusion device and a link according to the shape without any combining means such as bolts and nuts to enable a user to connect the road sign faster and more conveniently.

In addition, it solves corrosion due to the combining means to prevent the negative effect of damage in the appearance of the road sign due to rust generated by the corrosion.

Also, it installs a member for noise prevention on the space with the road sign additionally and solves the direct friction with the road sign to prevent noise and abrasion by the friction.

Lastly, even if the wind pressure acts back and forth the road sign by the wind etc., it allows the road sign to move back and forth naturally so as to reduce the impact on the road sign.

The above mentioned example of implementation is only an example, and anyone who has common knowledge about the field of the relevant technology can make different examples of implementation transformed from this in various ways.

Therefore, the scope of a true technical protection of this invention should include other examples of implementation in various ways as well as the above example of implementation of the technical idea of the invention stated in the below scope of patent claims.

1. A bracket apparatus for road sign comprising:
A connecting bracket including a protrusion device formed at the top thereof and a link with a side in a ring shape in which one end of the top opened longitudinally at the bottom thereof;
A member for noise prevention with a side in a ring shape cut out longitudinally so as to be installed inside the link horizontally in the tight fit method.

2. The bracket apparatus for road sign of claim 1,
Wherein the protrusion device of the connecting bracket has a “T” shaped section.

3. The bracket apparatus for road sign of claim 1,
Wherein the connecting bracket has multiple ribs with a given distance each other.

4. The bracket apparatus for road sign of claim 1,
Wherein the member for noise prevention includes Mono Cast (MC) nylon material.

5. The bracket apparatus for road sign of claim 1,
Wherein the member for noise prevention includes a first separator installed through the interior of one end of the link and a second separator installed through the interior of the other end of the link,
Wherein the first separator and the second separator have close protruded parts closed to the one end and the other end of the link and protrude ribs formed at the cut out part of the first separator and the second separator.

6. The bracket apparatus for road sign of claim 5,
Wherein a groove is formed on one side of the first separator so that the one side of the first separator is opened at an outside direction.
